(19) United States
(12) Patent Application Publication
(10) Pub. No.: US 2006/0088050 A1
(43) Pub. Date: Apr. 27, 2006

(54) System for a next generation wireless intelligent services engine (WISENG)

(75) Inventors: G.V. Kumar, Banjara Hills (IN); G.V.R. Nagaraju, Banjara Hills (IN); Mohan Kumar Sundaram, Banjara Hills (IN)

Correspondence Address: ARENT FOX PLLC, 1050 CONNECTICUT AVENUE, N.W., SUITE 400, WASHINGTON, DC, 20036, US

(73) Assignee: Xius India Ltd.

(21) Appl. No.: 11/233,405

(22) Filed: Sep. 23, 2005

Related U.S. Application Data
(63) Continuation-in-part of application No. PCT/IB04/01688, filed on May 24, 2004.
(60) Provisional application No. 60/472,716, filed on May 23, 2003.

(51) Int. Cl. H04J 3/22

(52) U.S. Cl. 370/465; 370/395.5

(57) ABSTRACT

WISE^{NG} offers true convergence of multiple protocols and integrates the services offered by providers in the telecommunication industry. The system provides a seamless, efficient and real-time way to connect multiple telecommunication services on a unified platform, with an additional integration with service, billing and rating engines. Additionally, the system is fully customizable to offer real time integration of multiple service applications on one end and multiple protocols on the other end. The system is also capable of providing multiple protocol integration without the need to replace the overall infrastructure of the provider. The system, therefore, reduces the complex protocol conversion and service integration efforts, minimizes administrative costs related to inter-working/billing and reduces the capital costs related to upgrading and maintaining the core infrastructure of the provider.

This application is a Continuation-In-Part Application of International Application Serial No. PCT/IB2004/001688, filed May 24, 2004, which claims priority to U.S. Provisional Application No. 60/472,716, filed May 23, 2003, the entire specifications, claims and drawings of which are incorporated herewith by reference.

### BACKGROUND OF THE INVENTION

1. Field of the Invention

The present invention relates to a system that enhances revenue and reduces costs by providing interoperability among multiple protocols on the same platform and by integrating services associated with the telecommunication industry.

2. Background of the Technology

The telecommunication industry, such as wire-line, cellular or digital telephone communication, is widespread and continues to grow and evolve rapidly. Providers (interchangeably referred to herein as “carriers” or “operators”) in the telecommunication industry have an enormous task of providing seamless communications to their end-parties (interchangeably referred to herein as “users” or “consumers” or “subscribers”). The telecommunication systems, which form the technological foundation of the telecommunication industry, however, are not currently able to provide operators with the scope of integrated functions and interoperability among themselves that are needed to keep up with the demands of the industry.

The current invention provides convergence across multiple protocols and generates convergent triggers to the service layers, which brings about a truly integrated convergent solutions platform.

For instance, one significant problem faced by the telecommunication industry is integrating signaling services (those that specifically provide wire-line and wireless communication), with administrative services, such as billing and revenue management. The administrative services are typically managed by operations support systems (OSS) (interchangeably referred to herein as the “platform”), which are generally systems that process information supporting various management functions, such as billing, customer care, network management, inventory control, maintenance, trouble ticket reporting, surveillance and service provisioning.

The current technology in the telecommunication field is increasingly encumbered by legacy operating systems that were developed with a compartmentalized, functional view of the providers operations. This also limited the scope of interoperability between various systems, involving multiple protocols. Thus, billing systems are developed in isolation from the network, and signaling plays a limited role in service creation. The net results are highly capable and robust OSS systems that perform well within a limited functional sphere of capabilities. Carriers typically spend great time and resources in bringing these different operational systems into a harmonious optimal relationship. As long as OSS and billing providers continue to take a narrow and compartmentalized perspective to system design, architecture, and performance, sub-optimization will be the norm.

There is an increased awareness and demand for a more integrated OSS protocols and network capabilities. Carriers are increasingly frustrated in being presented with dysfunctional systems that require extensive modifications before they can fully operate. The cost to the carrier can be incurred not only in terms of additional adaptation costs for interoperability but also in lost revenues as new service creation is delayed.

Carriers are also demanding greater real or near real time capabilities in the areas of real time service creation, quality of service optimization, and cost performance management from their OSS/Billing providers. The pressure on carriers to reduce costs, increase return on investment, and increase profitability has never been more severe.

For example, providers typically use numerous applications that may involve multiple protocols and platforms to carry out the plethora of services used by consumers. This approach is inherently flawed and creates disadvantages for the provider mainly because it limits the breadth of the applications. For instance, each application or platform used by the provider is focused on a specific task, thereby forcing the provider to compartmentalize activity. Compartmentalization is believed to be a narrow and inefficient method of addressing the activities of the provider.

Providers are increasingly growing frustrated with the reality of losses in revenue and the lack of available, easy-to-use remedies. For example, currently used technologies attempt to connect the multitude of services offered by providers by implementing extensive modifications to and upgrades of existing systems. This method of upgrading is not generally efficient; rather it has proven to be cost prohibitive due to the high costs associated with system testing, adaptation, and implementation. Moreover, this type of upgrade is commonly associated with numerous delays (due in part to the difficulty synchronizing older systems with newer applications. Delays usually result in additional lost revenue.

The present state of the technology also does not facilitate real-time processing. In particular, providers are limited in the areas of real-time service assessment and integration, quality of service optimization, and cost performance management. The inability to make real-time decisions and optimizations has an effect on the providers' revenue stream. For instance, in some cases, optimizations necessary to capture revenue are not implemented until a significant portion of available revenue is already lost.

It is widely believed that providers fail to collect significant amounts of revenue and that providers have unnecessary overhead that contributes to overall costs of operation. Accordingly, it is believed that providers suffer these losses of revenue, in part, because of 1) an inability of the present technology to accurately assess and collect revenue based on signaling or network use; 2) an inefficient method of processing revenue streams; and 3) unavailability of systems that provide seamless interoperability and thus providing transparent services to the users.

Thus, there remains an unmet need in the prior art for an elegant, intelligent and efficient telecommunication system that provides carriers with a single OSS platform integrating and implementing multiple systems, multiple protocols, services, solutions and applications from third party technology vendors. There also remains an unmet need in the art for an OSS platform that facilitates upgrades, customization, and general usability, while providing an enhancement for revenue collection and cost reduction of services associated with network operation.

### SUMMARY OF THE INVENTION

The present invention provides an underlying platform layer that can remain a static core that works on multiple protocols; on which newer applications can be built; innovative services can be launched, without having to replace high cost capital infrastructure again and again as the technology matures. Products, services, and applications can become obsolete, but the capital infrastructure should not necessarily become obsolete as well.

Two core elements, which provide the underlying logic for all services—old and new—for the last 20 years and do not change for wireless carriers, are signaling and billing. The present invention provides one such pioneering technology platform and layer, which uniquely combines multiple signaling protocols and real-time rating engines to form a core on which applications can rest. The present invention uses signaling to transmit data, probe network operations, and distribute information in real time, thus creating innovative services, while seamlessly combining rating engines and billing elements to charge for these services in real time.

The present invention, which in one embodiment is referred to as the Next Generation Wireless Intelligent Services Engine (also interchangeably referred to herein as the “system” or simply WISE^{NG}), may also provide a robust, multi-layer OSS platform that integrates numerous services offered by a provider into an operational system. WISE^{NG} assists providers to maximize revenues and to reduce costs. In particular, the present invention provides a single, advanced real-time and integrated signaling and billing system, which forms the basis for all wireless communications services and associated services. The system integration is provided through the OSS platform, which incorporates signaling protocols to transmit data (e.g., via signaling system 7 (SS7) or C-7 signaling of GSM or CDMA, etc), the probing of network operations, and the distribution of information in real-time. As a result, the system of the present invention seamlessly allows the providers' rating engines and billing elements to charge for communication services in real-time.

In one more aspect of the present invention, the present invention increases the general application and usability of the operation system, in comparison to conventional operating systems. In particular, the system of the present invention is designed to be easily implemented, customized, and upgraded.

The system allows providers to efficiently and cost-effectively implement the system. The system does not require extensive modifications before the system is fully operational, thereby saving the provider from high implementation costs and delays that are typically associated with application upgrades. Moreover, the system can be customized to accommodate the needs of each provider. Thus, the present invention is highly scaleable and provider-specific.

Furthermore, the system of the present invention is fully and conveniently upgradeable. The system provides a static core on which newer applications can be built and innovative services can be launched without having to replace the capital infrastructure over time. Applications can be integrated with the core infrastructure using industry standard connections and protocols, as are generally known in the art.

Generally, the WISE^{NG} architecture includes a series of inter-relating layers. The central layers include multi protocol layer, protocol adaptation & inter-working layer, service broker layer, service authentication layer, and service interface layer.

To achieve the foregoing objects, and in accordance with the purpose of the invention as broadly described herein, the present invention provides a platform to enhance the scope of seamless interoperability across various protocols, carrier revenues and reduce network costs. The preferred embodiment of the present invention can be deployed in telecommunication networks.

Additional advantages and novel features of the present invention will become more apparent from the following description.

### BRIEF DESCRIPTION OF THE DRAWINGS

FIG. 1 illustrates an exemplary Wireless Intelligent Services Engine architecture, wherein numerous functional layers are integrated, in accordance with one embodiment of the present invention.

FIGS. 2 and 3 show an exemplary functional overview of the system, in accordance with one embodiment of the present invention.

FIG. 4 presents hardware, software or a combination thereof that may be implemented in one or more computer systems or other processing systems to carry out the functionality of the present invention illustrated in FIGS. 1-3.

FIG. 5 represents an exemplary Next Generation Wireless Intelligent Services Engine (WISE^{NG}) architecture, wherein various functional layers are integrated, in accordance with one embodiment of this improvised invention.

Other features of the present invention will become apparent from the following detailed description considered in connection with the accompanying drawings, which disclose multiple embodiments of the present invention. It should be understood, however, that the drawings are designed for the purpose of illustration only and not as a definition of the limits of the invention. Additional advantages and novel features of the invention will also become more apparent to those skilled in the art upon examination of the following or upon learning by practice of the invention.

### DETAILED DESCRIPTION OF THE PRESENT INVENTION

The present invention provides an innovative OSS platform that adapts multiple protocols and provides inter-working among the protocols. Major enhancement in the current invention is that the platform provides convergence across protocols in a true sense. This also allows integrating signaling and billing technologies to allow real-time transactions and system assessment and/or management.

The system of the present invention provides an underlying platform layer that can remain as a static core and that can serve as the capital infrastructure for the provider. The static core generally includes two elements: signaling and billing that provide the underlying logic for most, if not all, services in the telecommunication industry. The present invention uniquely combines multiple protocols and real-time rating engines to form a core on which other applications are built and implemented. This core may also interface with third party applications and hardware. As a result, the present invention seamlessly integrates signaling, which is used to transmit data, probe network operations, and distribute information in real-time, with rating engine service and billing services to permit real-time assessment, management, and accounting of these services. This makes the present invention a comprehensive telecommunication’ solutions platform.

The system can be initially developed with one or more service layers, each of which performs services related to the telecommunication industry. The implementation of the system may be provider-specific to meet the exact needs of each provider.

The static core may be upgraded and expanded to accommodate the changing needs of each provider. For example, products, services, and applications, which can be rendered obsolete over time, can be replaced with state of the art applications on the system of the present invention. Generally, the replacement applications are interfaced with the system of the present invention using industry standard interfaces, which are generally known in the art. Accordingly, the system of the present invention can add multiple service layers to provide additional wireless communication services currently known or developed in the future.

Furthermore, the system of the present invention may be easily added to the existing capital infrastructure without high levels of adaptation or the need to replace significant amounts of hardware. Maintenance of the present system is also facilitated because vendor-specific information for each application and customization may not be required.

For the purposes of this application, Table 1 provides standard abbreviations for terms.

TABLE 1

| Abbreviation | Description |
|---|---|
| OSS | Operations Support System |
| ISUP | Integrated Services User Part |
| INAP | Intelligent Network Application Part |
| CAP | Camel Application Part |
| CAMEL | Customized Applications Mobile Enhanced Logic |
| SAL | SS7 Adaptation Layer |
| NBL | Network Broker Layer |
| OSA | Open Services Access |
| XML | Extensible Markup Language |
| IDL | Interface Definition Language |
| MAP | Mobile Application Part |
| API | Application Program Interface |
| WISE | Wireless OSS Platform |
| WIN | Wireless Intelligent Network |
| MMS | Multimedia Messaging System |
| UMS | Unified Messaging System |
| EMS I | Enhanced Messaging System |
| SIP | Session Initiation Protocol |
| CDMA | Code Division Multiple Access |
| IP | Internet Protocol |
| VoIP | Voice over IP |
| GSM | Global System for Mobile Communications |

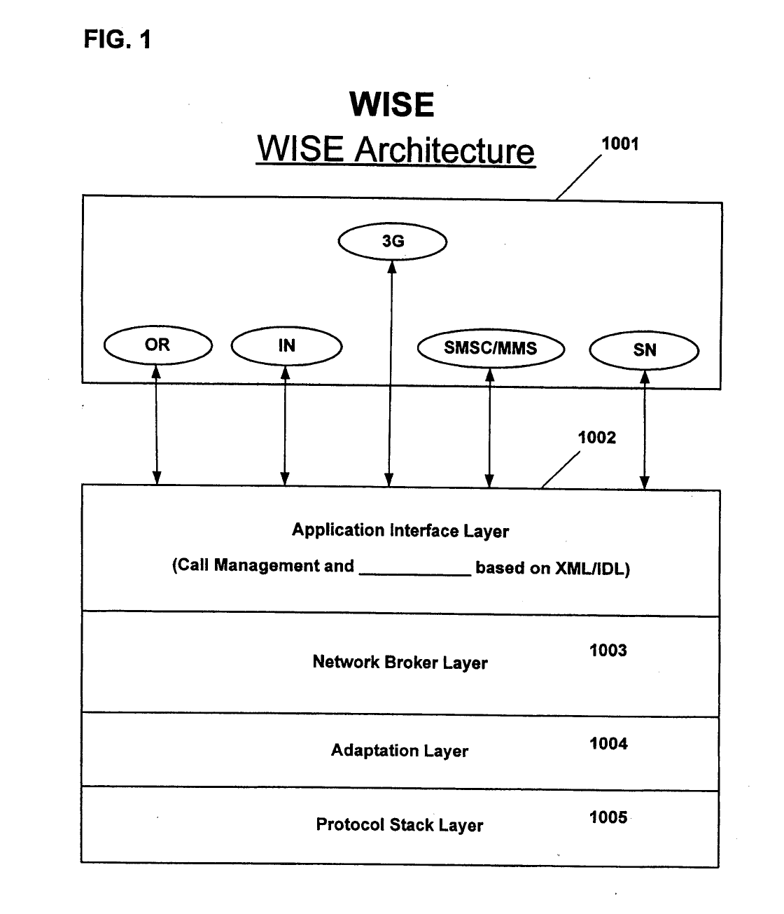

According to FIG. 1, which represents one embodiment of the WISE architecture, a protocol stack layer (PSL) 1005, an adaptation layer 1004, a network broker layer (NBL) 1003, an application interface layer (AIL) 1002 and an application layer 1001 are combined.

The top layer schematically in FIG. 1 is the application layer 1001, which provides the interface with external applications and interfaces with below layers via industry standard interfaces, such as interface definition language (IDL), open services access (OSA), and extensible mark-up language (XML). In this embodiment, the application layer may include external applications, such as, for example, multimedia messaging system (MMS), short message service center (SMSC), intelligent network (IN), Third Generation (3G) wireless systems, Service Node (SN), and Optimal Routing (OR).

The system of the present invention can run numerous applications. For instance, the system can run an intelligent network based mobile pre-paid platform with great rating flexibility and rapid service creation and deployment functionality, such as Mobile VPN, CUG, Mobile Office, and services generally described in the International Telecommunication Union—Telecommunication Standardization Sector (ITU-T) recommendations IN CS-1, CS-2, and CS-3. The system of the present invention can also run an application for an optimal routing functionality, which can be achieved through quickly and efficiently subscribing to and calling the call management APIs. Other applications capable of running on the system of the present invention include, for example, 3G services, dual IMSI-based roaming, missed call alerts, welcome SMS alerts while roaming, location-based services, mobile prepaid services based on service node technology, mobile pre-paid roaming applications using the call management APIs and rating APIs to provide pre-paid roaming services, SMS, EMS, UMS, and MMS services, postpaid and prepaid billing, and prepaid roaming and non-roaming based on CAMEL phase II, III and IV.

The layer below the application layer 1001 is the application interface layer (AIL) 1002. The AIL 1002 provides the published application programming interfaces (APIs), such as call management and rating, which are generally known in the telecommunication arts. In one embodiment, the APIs are derived from industry standards, such as Parlay and XML.

The AIL 1002 is developed using the concepts of inter-operability and scalability. For example, in one variation of the present invention, interoperability is facilitated by using Common Object Request Broker Architecture (CORBA®). CORBA® is a vendor-independent architecture and infrastructure that computer applications use to work together over networks. Using the standard protocol IIOP, a CORBA-based program from any vendor, on almost any computer, operating system, programming language, and network, can interoperate with a CORBA-based program from the same or another vendor, on almost any other computer, operating system, programming language, and network. Other examples of interoperability include XML, java native interface (JNI), and Interface Definition Language (IDL).

The AIL 1002 may interface with the layers below via industry standard interfaces, such as IDL, OSA, and XML. In one embodiment, the APIs are derived from industry standards, such as Parlay and XML.

In an embodiment of the present invention according to FIG. 1, the layer schematically below the AIL 1002 is the network broker layer (NBL) 1003. The functionality of this layer is to interface with the network layer and to specified access components. The specified access components are specific protocols, such as wireless intelligent network (WIN), integrated services user part (ISUP), intelligent network application part (INAP), mobile application part (MAP), Transaction Capabilities Application Part (TCAP), Signaling Connection Control Part (SCCP) and/or customized applications mobile enhanced logic (CAMEL) application part (collectively known as “CAP”). In one variation, there are specified access components to the wireless domain (e.g., Wireless Access Components).

The applications register and subscribe to the services offered by the NBL 1003. The NBL 1003 is capable of addressing various protocols under signaling. In one variation, the 3G related applications are registered and subscribed to telecom access components. To support 3G requirements, for example, both SS7 and IP protocols are subscribed to and registered by applications.

Additionally, the NBL 1003 interfaces with vendor-specific APIs transparent to the application (e.g. NetStructure, manufactured by Intel of Santa Clara, Calif. and Opencall manufactured by Hewlett Packard of Palo Alto, Calif.). Additionally, in one variation, the NBL 1003 also supports network management functionality, so as to ensure that proper fault and alarm reporting is carried out apart from having the flexibility in managing and fixing faults. In another variation, the NBL 1003 also provides network statistics based on the applications subscribed thereon.

Schematically below the network broker layer 1003 shown in to FIG. 1 is the adaptation layer 1004. The purpose of the adaptation layer 1004 is to convert the various APIs (e.g., SS7) provided by each vendor to a common framework of messages. In one variation involving SS7, for example, any new SS7 stack can be implemented quickly and efficiently. This adaptation layer 1004, typically, avoids the need to test the complete functionality of the entire system after each software/hardware change.

As shown in FIG. 1, the protocol stack layer 1005 is schematically disposed below the adaptation layer 1004. The purpose of the protocol stack layer 1005 is to facilitate interconnection and exchange of information between users in a communications system. The hardware and software functions of the SS7 protocol are divided into functional abstractions called “levels.” These levels map loosely to the Open Systems Interconnect (OSI) 7-layer reference model defined by the International Standards Organization (ISO).

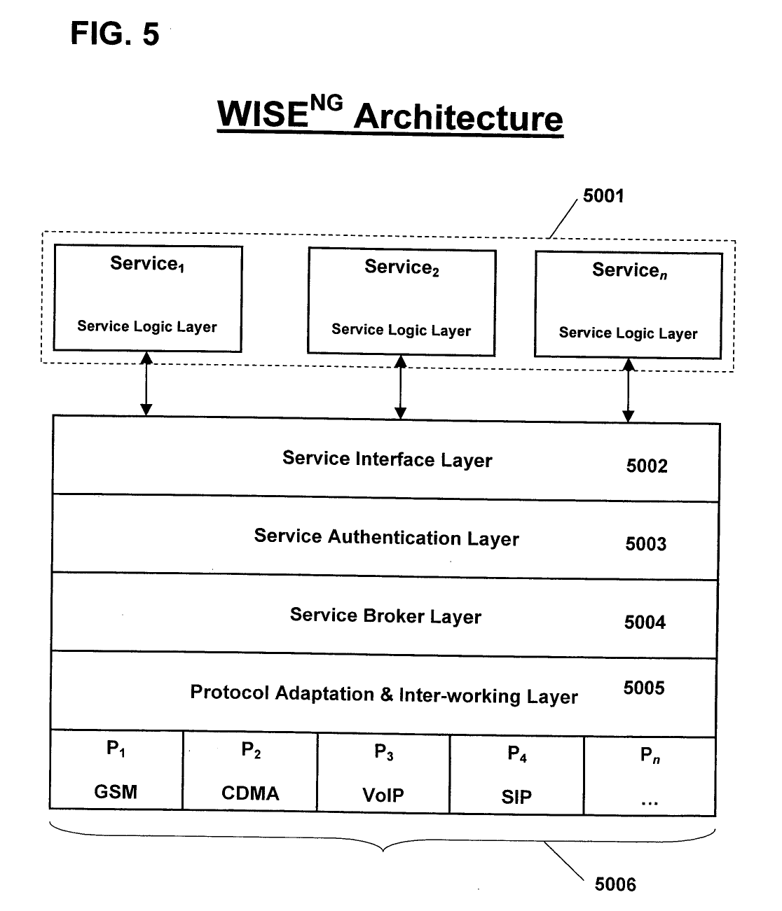

According to FIG. 5, which represents embodiment of the WISE^{NG} architecture, multiple protocol layer 5006, protocol adaptation & inter-working layer 5005, service broker layer 5004, service authentication layer 5003, and service interface layer are combined.

The top layer schematically in FIG. 5 is the service interface layer 5002, which provides the programmable interface to external applications and interfaces with below layers via industry standard interfaces, such as interface definition language (IDL), open services access (OSA), and extensible mark-up language (XML). In this embodiment, the service interface layer 5002 may include external applications, such as, for example, multimedia messaging system (MMS), short message service center (SMSC), intelligent network (IN) and Third Generation (3G) wireless systems.

The system of the present invention can run numerous applications, under the service logic layer 5001. For instance, the system can run an intelligent network based mobile pre-paid platform with great rating flexibility and rapid service creation and deployment functionality, such as Mobile VPN, CUG, Mobile Office, and services generally described in International Telecommunication Union—Telecommunication Standardization Sector (ITU-T) recommendations IN CS-1, CS-2, and CS-3. The system of the present invention can also run an application for an optimal routing functionality, which can be achieved through quickly and efficiently subscribing to and calling the call management APIs. Other applications capable of running on the system of the present invention include, for example, 3G services, dual IMSI-based roaming, missed call alerts, welcome SMS alerts while roaming, location-based services, mobile prepaid services based on service node technology, mobile pre-paid roaming applications using the call management APIs and rating APIs to provide pre-paid roaming services, SMS, EMS, UMS, and MMS services, postpaid and prepaid billing, and prepaid roaming and non-roaming based on CAMEL phase II, III, and IV.

The layer below the service logic layer 5001 is the service interface layer 5002. The service interface layer 5002 provides the programming interfaces (APIs) to the host and external applications, such as call management, rating, etc., which are generally known in the telecommunication arts. In one embodiment, the APIs are derived from industry standards, such as Parlay and XML.

The service interface layer 5002 may interface with the layers below via industry standard interfaces, such as Interface Definition Language (IDL), Open Services Access (OSA), and Extensible Markup Language (XML).

In an embodiment of the present invention according to FIG. 5, the layer schematically below the service interface layer 5002 is the service authentication layer 5003. The functionality of this layer is to authenticate various registered services on the platform.

In an embodiment of the present invention according to FIG. 5, the layer schematically below the service authentication layer 5003 is the service broker layer 5004. The applications register and subscribe to the services offered by the service broker layer 5004. The service broker layer 5004 routes messages to appropriate service application.

Additionally, the service broker layer 5003 interfaces with vendor-specific APIs transparent to the application. Additionally, in one variation, the service broker layer 5004 also supports network management functionality, so as to ensure that proper fault and alarm reporting is carried out apart from having the flexibility in managing and fixing faults. In another variation, the service broker layer 5004 also provides network statistics based on the applications subscribed thereon.

Schematically below the service broker layer 5004 shown in to FIG. 5 is the protocol adaptation & inter-working layer 5005. The purpose of the protocol adaptation & inter-working layer 5005 is to map & convert the various layers of multiple protocols (e.g., CAP-SS7, IS41-SS7) to a common framework of messages, handles state management and triggers appropriate messages to service layer. In one variation involving SS7, for example, any new stack can be implemented quickly and efficiently. This layer 5005, typically, avoids the need to recreate the technology to adapt to various domain protocols or interface and provides an abstract messaging with state and trigger function for each state.

As shown in FIG. 5, the multiple protocol stack layer 5006 is schematically disposed below the protocol adaptation & inter-working layer 5005. The purpose of the multiple protocol stack layer 5006 is interconnection and exchange of information between users in a multi-communications system.

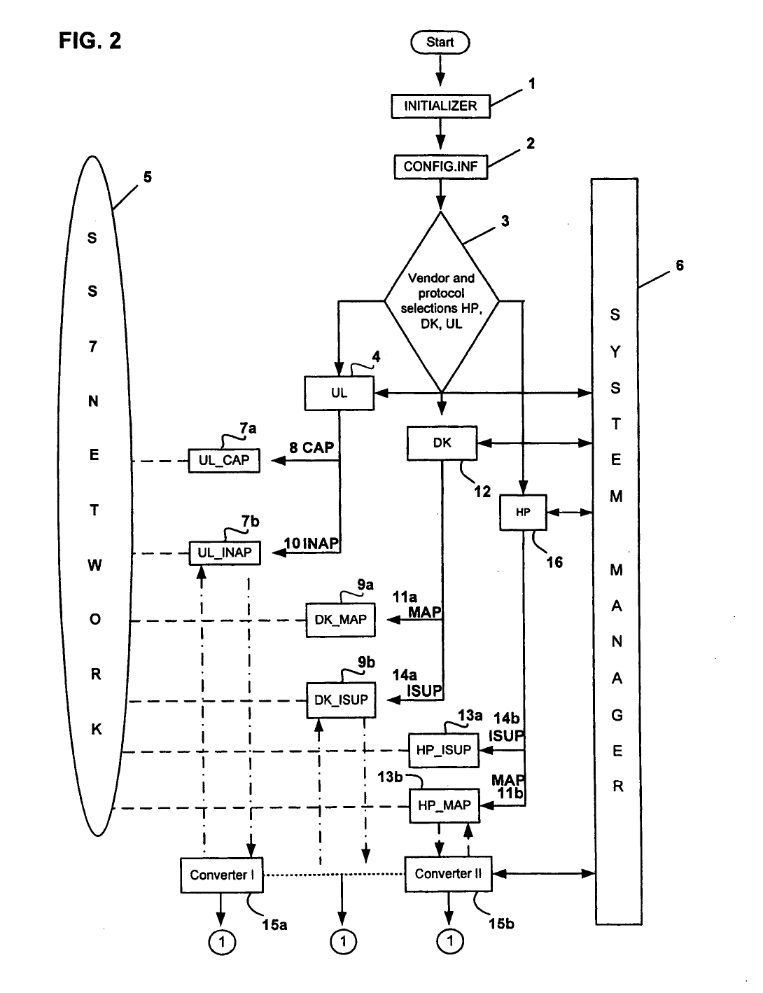

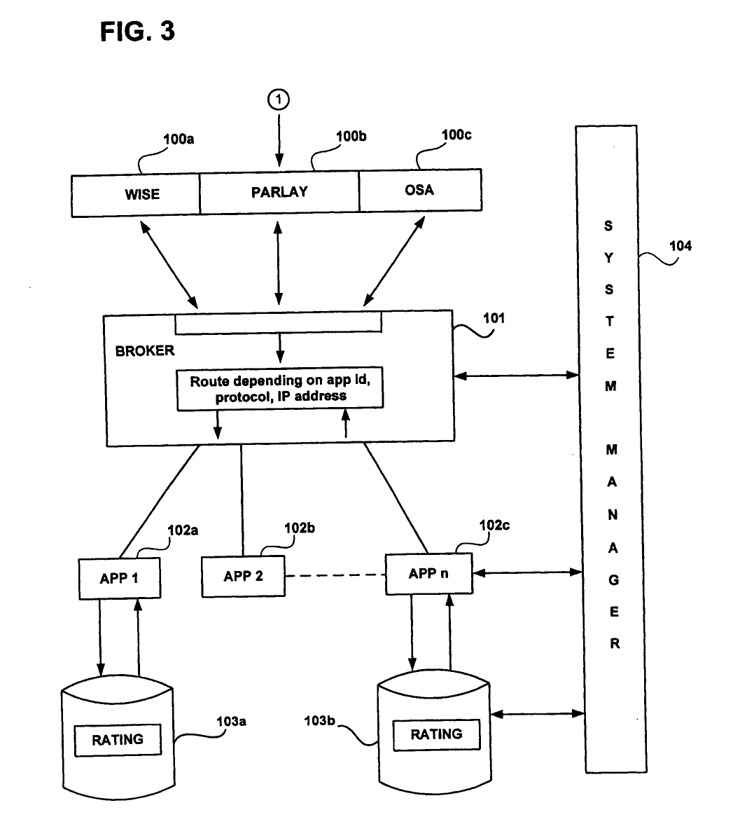

FIGS. 2 and 3 provide functional overviews of the system of the present invention. In FIG. 2, the process begins with the initializer 1 executing the process(es) obtained from a file containing configuration information, such as config.ini 2 (also referred to herein interchangeably as “configuration information”). The initializer also may start or initialize the various protocol stacks configured in the config.ini 2 file.

Typically the config.ini 2 file stores application information. For example, the config.ini 2 (or an equivalent file) includes the number of applications, the name of applications, and ID for applications. The config.ini 2 file may include stack information, including the type of stack and the protocol used. Example stacks optionally include SS7, TCP/IP, SIP, etc from different vendors.

Additionally, in yet another variation, the config.ini 2 file includes converter information. The converter information may include, for example, the number of converters per stack and the converter type. The converter type information may include the socket and/or pipe.

The config.ini 2 file may also include fail-safe information. The fail-safe information includes stack level fail-safe information (e.g., HP, DK, or ULTICOM) and the converter level fail-safe information. The converter level fail-safe information may include this information for each converter level (e.g., 1, 2, 3, . . . n).

The config.ini 2 file may also include: 1) a broker configuration, which may include information, such as an application ID, protocol ID, application IP address; 2) broker level fail-safe information, which may include the broker ID 3) API information and/or format, which may include interface information, such as the WISE^{NG} format; and 4) information on IP addresses, which may include whether the address is active or in stand by.

In decision box 3, the particular vendor and/or protocol for the desired process are selected. The vendor and protocol selections may optionally include, for example, HP 16, DK 12, and ULTICOM 4 (also referred to herein as “UL”).

After a vendor and protocol is selected, the initializer starts the corresponding stacks. For instance, consider ULTICOM 4 is one of the stacks, including protocols, started by the initializer 1. The ULTICOM 4 stack(s) communicate in the SS7 network 5 using, for example, E1/T1 interfaces, via CAP 8 and INAP 10. Accordingly, this leads to UL_CAP 7a and UL_INAP 7b.

For instance, consider DK 12 is one of the stacks, including protocols, started by the initializer 1. The DK 12 stacks communicate in the SS7 network using E1/T1 interfaces, via ISUP 14a and MAP 11a. Accordingly, this leads to DK_ISUP 9a and DK_MAP 9a.

For instance, consider HP 16 is one of the stacks, including protocols, started by the initializer 1. The HP 16 stacks communicate in the SS7 network 5 using E1/T1 interfaces, via ISUP 14b and MAP 11b. Accordingly this leads to HP_ISUP 13a and DK_MAP 13b.

Converters 15a and 15b, for example, receive the message from the various stacks, e.g., UL 4, DK 12, and HP 16, and convert them to configured API formats. In one variation, as shown in FIG. 3, the three types of API formats generated are WISE 100a, PARLAY 100b, and OSA 100c, which are the formats in the config.ini 2 file.

The converters may operate under fail-safe configuration, if configured to do so in the config.ini 2. The number of converters 15a and 15b, as shown in FIG. 2, is dependent on the traffic the system is designed to support. Under the fail-safe condition one converter 15a and 15b may execute in each machine/system. In some embodiments, a pair of converters may execute in the other machine/system (active and stand by servers).

Once the converters 15a and 15b receive the messages from the stacks and convert them to configured API formats, the API formats are forwarded to the broker 101, as shown in FIG. 3. All the applications register with the broker 101 using an application ID, a protocol ID, and an IP address.

The system manager 6 (FIG. 2) and 104 (FIG. 3) serves as the system administrator (interchangeably referred to herein as “monitor”) to ensure the functionality of each element, i.e., the broker 101, the converters 15a and 15b, and the stacks 4, 12, and 16. In the event that there is a malfunction, the system manager 6 and 104 identifies and remedies the malfunction. Additionally, the system manager 6 and 104 may alert the operator of the malfunction with an alarm. In one variation, the system manager 6 and 104 can automatically initiate additional processes to ensure high availability of the services.

The broker 101 routes the APIs to the appropriate application 102a, 102b, and 102c based on the application ID, the protocol ID, and the IP address. In one variation, application 102a addresses pre-paid applications. In this variation, the application interfaces with the rating engine 103a with standard SQL statements. In another variation, application 102a is a messaging application. Thus, multiple applications 102a, 102b, and 102c can be developed within the same broker 101.

The following illustrates three examples of implementations and resulting effectiveness of the system of the present invention. The first two examples are comparative examples of conventional systems and the problems associated therewith. The third example is illustrative of the how the system of the present invention assists providers and improves upon the conventional systems.

Comparative Example 1. A large wireless communications provider uses multi-vendor platforms as the infrastructure to support wireless communication and related services. The provider uses numerous services, which are functional on separate hardware. Table 2 lists the services and platforms that are used by the provider.

TABLE 2

| Services | Equipment/Platform | Vendor |
|---|---|---|
| Mobile Voice Telephony | MSC/VLR & HLR | Siemens, Nokia and |
| | | Ericsson |
| Data (SMS) | Unix | Nokia |
| GPRS | Unix | Nokia |
| Prepaid IN | Unix | Siemens |
| Prepaid IN | Windows | Vendor 1 |
| Prepaid Roaming | Windows | Vendor 2 |
| Optimal Routing | Windows | Vendor 3 |
| Welcome SMS | Windows | Vendor 4 |
| Postpaid Billing | Sun Solaris | Vendor 5 |

Table 2 presents a typical case in which the provider uses multiple platforms/equipment to support various services. As a result, the provider must ensure complete and accurate integration of these services with one another to provide 100% optimization to the end user. In the event that the provider is unable to provide 100% optimization, the provider has limited options to address the situation and attempt to reach 100% optimization. For instance, the provider can obtain support from each vendor to determine whether each vendor's services are operational and optimized. However, each vendor is only able to address the problems associated with the vendor-specific application. A vendor of one protocol cannot typically address the problems associated with another protocol. Thus, the provider must rely on numerous vendors for support. By relying on the various vendors for assistance, the provider invests substantial amount of time and resources. In practical terms, addressing problems in this manner (e.g., obtaining expert support from each vendor) is typically associated with significant costs. In addition, the provider is typically unable to obtain information from vendors on how the individual applications should be integrated with one another. Therefore, having multiple platforms/equipment installed at the provider invites huge network integration costs and the likelihood of decreased revenues due to a high turnover of subscribers, i.e., unsubscribing from the services of the carrier.

Comparative Example 2. A large provider uses a single vendor platform as the infrastructure to support various services offered by the provider. Table 3 illustrates the various services offered by the provider and the corresponding platforms used to support the services.

TABLE 3

| Services* | Equipment/Platform | Vendor |
|---|---|---|
| Mobile Voice Telephony | MSCNLR & HLR | Siemens |
| Data (SMS) | Unix | Single Vendor |
| GPRS | Unix | Single Vendor |
| Prepaid IN | Unix | Single Vendor |
| Prepaid Roaming | Unix | Single Vendor |
| Optimal Routing | Unix | Single Vendor |
| Welcome SMS | Unix | Single Vendor |
| Postpaid Billing | Unix I | Single Vendor |

Thus, Table 3 depicts a typical case where the provider installed various services of a single vendor on separate hardware to support those services. In this example, the maintenance costs of such hardware is prohibitively high, and the provider is accordingly extremely dependent on the single vendor. Additionally, the provider is limited to services that are provided by the single vendor, thereby limiting the scope of the providers' services to those offered by the single vendor. Moreover, the problem of limited scope of services is further exacerbated because the single vendor infrastructure does not permit third-party services to be implemented. The net result for the provider includes limited services offered, restricted revenue growth, and a potential loss of customers to market competitors providing a wider scope and range of services.

Example 3. The following example involves a large provider using the platform of the present invention, in accordance with one embodiment, as infrastructure to support various services. In this variation, the infrastructure is hardware and operating system independent, thereby increasing the versatility and applicability of the platform. Table 4 presents the various services provided the provider in this embodiment.

TABLE 4

| Services* | Equipment/Platform | Vendor |
|---|---|---|
| Mobile Voice Telephony | MSC/VLR & HLR | Siemens |
| Data (SMS) | OS Independent | Single Vendor/Multi |
| GPRS | (Unix, Solaris, Linux) | Vendor |
| Prepaid IN | HM independent | (Multi Vendor for |
| Prepaid Roaming | (HP, SUN, INTEL) | hardware and |
| Optimal Routing | | applications is |
| Welcome SMS | | possible), but |
| Postpaid Billing | | not recommended |
| Option/Interface for Carrier | | |
| to add 3rd party services | | |

Table 4 depicts a typical case where the Wireless carrier has a single vendor and has installed scaleable hardware that supports various services. The infrastructure provided by the present invention creates an interface that can communicate with (e.g., “plug into”) any numerous third party services that operate in universally accepted formats and industry standard interfaces (e.g., XML, CORBA).

In another example, a large wireless communications provider uses multi-vendor platforms as the infrastructure to support wireless communication and related services. The provider uses numerous services, which are functional on separate hardware.

This example presents a typical case in which the provider uses multiple platforms/equipment to support various services, the provider must ensure complete and accurate integration of these services with one another to provide 100% optimization to the end user. In the event that the provider is unable to provide 100% optimization, the provider has limited options to address the situation and attempt to reach 100% optimization. For instance, the provider can obtain support from each vendor to determine whether each vendor's services are operational and optimized. However, each vendor is only able to address the problems associated with the vendor-specific application. A vendor of one protocol cannot typically address the problems associated with another protocol. Thus, the provider must rely on numerous vendors for support. By relying on the various vendors for assistance, the provider invests substantial amount of time and resources. In practical terms, addressing problems in this manner (e.g., obtain expert support from each vendor) is typically associated with significant costs. In addition, the provider is typically unable to obtain information from vendors on how the individual applications should be integrated with one another. Therefore, having multiple platforms/equipment installed at the provider invites huge network integration costs. The following example involves a large provider using the platform of the present invention, in accordance with one embodiment, as infrastructure to support various services. In this variation, the infrastructure is hardware and network protocol/connectivity independent, thereby increasing the versatility and applicability of the platform. The infrastructure provided by the present invention creates an interface that can communicate with (e.g., “plug into”) any numerous third party services that operate in universally accepted formats and industry standard interfaces (e.g., XML, CORBA).

Thus, with the implementation of the present invention, the provider obtains a number of advantages, including interoperability between multiple network interfaces, decreased maintenance costs and a resulting minimization of network costs. It should be noted that maintenance of the infrastructure does not require vendor-specific assistance or hardware.

The provider also has an option to increase services developed by third parties on the existing platform (single or multiple hardware boxes). This potential for expansion provides the carrier with flexibility to increase services and/or provide additional services to its customers, thereby enhancing revenue and providing a basis for a substantial decrease in network costs.

The present invention allows providers to reduce capital expenses and operational expenses. This reduction in expenses is significant when compared to the industry standard costs for implementing and maintaining a core infrastructure. Accordingly, as the costs decrease, the provider is able to increase revenue, or at the least, pass the financial benefit to the end user maintaining the same similar revenues.

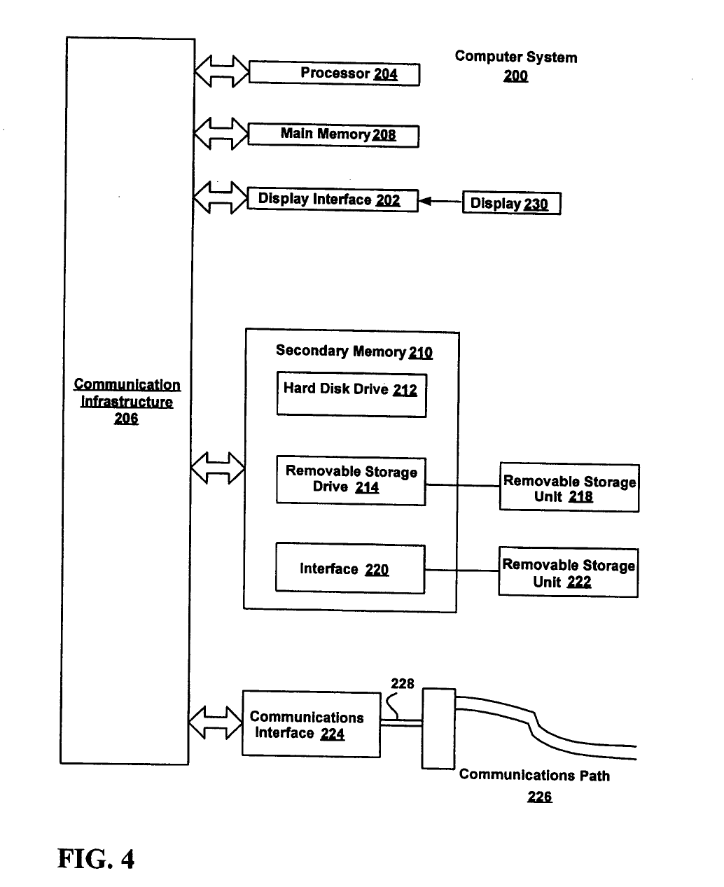

The present invention may be implemented using hardware, software, or a combination thereof and may be implemented in one or more computer systems or other processing systems. In one embodiment, the invention is directed toward one or more computer systems capable of carrying out the functionality described herein. An example of such a computer system is shown in FIG. 4.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that transmits graphics, text, and other data from the communication infrastructure 206 (or from a frame buffer not shown) to the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218 may represent a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other devices for allowing computer programs or other instructions to be loaded into computer system 200. Such devices may include, for example, removable storage unit 222 and interface 220. Removable storage unit 222 and interface 220 may include a program cartridge and cartridge interface (such as that found in video game devices), a removable memory chip (such as an erasable programmable read only memory (EPROM), or programmable read only memory (PROM)) and associated socket, etc., which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, removable storage drive 222, RAM, ROM, EPROM, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drives 214, removable storage drive 222, RAM, ROM, EPROM, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

While there has been described what are at present considered to be preferred embodiments of the present invention, it will be understood that various modifications may be made thereto, and it is intended that the appended claims cover all such modifications as fall within the true spirit and scope of the invention. Other modifications will be apparent to those skilled in the art.

What is claimed is:

1. A system for providing core infrastructure for telecommunication industry, the system comprising:
multiple protocol layer;
protocol adaptation & inter-working layer, schematically disposed above the multiple protocol layer. This provides protocol conversion gateway and state management with trigger enablement to service layer;
service broker layer, functionally connected to the protocol adaptation layer and routes the message to appropriate service application;
service authentication layer, which authenticates various registered services;
service interface layer, which is functionally connected to the service authentication layer, provides programmable interfaces to external applications by means of APIs to access service logic layer.

2. The system according to claim 1 includes signaling elements, and optionally billing elements seamlessly integrated in real-time.

3. The system according to claim 1, wherein the system is customizable and the network interface is independent.

4. The system according to claim 1, wherein the system is scaleable.

5. The system according to claim 1 wherein the system upgradeable with applications using industry standards.

6. The system according to claim 1, wherein the external applications are any one selected from a group consisting of multimedia messaging system, short messaging service center, intelligent network, third generation systems, and OR

7. The system according to claim 1, wherein the application interface layer interfaces via the industry standard formats which include any one selected from the group consisting of interface definition language, open services access, and extensible markup language.

8. The system according to claim 1, wherein the network broker layer interfaces with access components.

9. The system according to claim 1, wherein access components include one protocol selected from the group consisting of wireless intelligent network, integrated services user part, intelligent network application part, customized applications mobile enhanced logic application part, and mobile application part.

10. The system according to claim 1, the system further comprising protocol adaptation & inter-working layer serving to convert multiple network protocol interfaces from each respect vendor to a common framework of messages.

11. A system for providing core infrastructure in the wireless communication, the system comprising:
a file having configuration information;
an initializer that executes the file having configuration information;
a plurality of protocol selections initiated by the initializer and communicating with a network;
a converter receiving messages from the plurality of protocol selections and converting the messages to an application programming interface format;
a broker receiving and registering the applications from the inter-working layer; and
a system manager monitoring the functions of any one of the group consisting of the initializer, file having configuration information, the plurality of protocol selections, the converter and the broker.

12. A system according to claim 11, wherein the system manager raises an alarm upon failure of one selected from the following group consisting of the broker, the converter, the plurality of protocol selections, the initializer, and the file having configuration information.

13. A system according to claim 11, wherein the broker registers the applications using any one selected from the group consisting of application identification, protocol identification, and an IP address.

14. A system according to claim 11, wherein file having configuration information includes one selected from a group consisting of application information, stack information, converter information, and fail-safe information.

15. A system according to claim 11, wherein the converter converts messages to API formats from one selected from the following group consisting of WISE^{NG} format.

16. A system according to claim 15, wherein the converter converts to WISE^{NG} format.

17. A system according to claim 14, wherein stack information is one of selected from the group consisting of stack type and protocol used.

18. A system according to claim 17, wherein the protocol is one selected from the telecommunication group optionally consisting of ISUP, MAP, ISUP, MAP, CAP, INAP, IS-41, IS-41D, IS-826, etc.

19. A system according to claim 14, wherein the converter information is one selected from the group consisting of the number of converters and converter type.

20. A system according to claim 19, wherein the converter information is one selected from the group consisting of socket and pipe.

21. A system according to claim 14, wherein the fail-safe information is one selected from the group consisting of stack level fail-safe, converter level fail-safe, broker configuration, broker level fail-safe, API information, and IP address.

22. A system according to claim 14, wherein the broker level fail-safe comprises a broker ID

23. A system according to claim 14, wherein the IP address is active.
